(19) United States
(12) Patent Application Publication
(10) Pub. No.: US 2007/0269252 A1
(43) Pub. Date: Nov. 22, 2007

(54) Write and Correct

(76) Inventor: Rhonda M. Burton, Waterford, MI (US)

Correspondence Address: WARN, HOFFMANN, MILLER & LALONE, .P.C, PO BOX 70098, ROCHESTER HILLS, MI, 48307, US

(21) Appl. No.: 11/799,964

(22) Filed: May 3, 2007

Related U.S. Application Data
(60) Provisional application No. 60/746,465, filed on May 4, 2006.

(51) Int. Cl. B05C 1/00; A47L 1/08

(52) U.S. Cl. 401/25; 401/17; 401/195

(57) ABSTRACT

The present invention is directed to a writing instrument having a housing with both a writing portion and a correction portion. The writing portion is at least partially contained in the housing and has a writing tip extendable from the housing. The correction portion of the writing instrument is at least partially disposed in the housing. The correction portion has an application that is connectable to the housing and is used to dispense correction material from the correction portion.

### CROSS-REFERENCE TO RELATED APPLICATIONS

This application claims the benefit of U.S. Provisional Application No. 60/746,465, filed May 4, 2006. The disclosure of the above application is incorporated herein by reference.

### FIELD OF THE INVENTION

The present invention relates to writing instruments having integrated correction components.

### BACKGROUND OF THE INVENTION

In the writing and stationary supply field there exist various types of writing instruments and accessories. For example, there are traditional and mechanical pencils which use a piece of lead, graphite or suitable material to leave a mark. In order to correct mistakes pencils often have an attached eraser for erasing the mistakes. Other types of writing instruments include pens which typically have no attached way of correcting mistakes. Therefore, writers who use pens must be careful to make no mistakes or they can use a correction accessory to cover their mistake. The correction accessory is a separate instrument that will employ some type of correction fluid or tape for correcting the mistakes. This creates clutter and complicates the writing process because ink pen users will need to carry extra instruments in order to correct their mistakes.

It is therefore desirable to develop writing instruments that have both a writing portion and a correction portion included in the same instrument.

### SUMMARY OF THE INVENTION

The present invention is directed to a writing instrument having a housing with both a writing portion and a correction portion. The writing portion is at least partially contained in the housing and has a writing tip extendable from the housing. The correction portion of the writing instrument is at least partially disposed in the housing. The correction portion has an applicator that is connectable to the housing and is used to dispense correction material from the correction portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side cross-sectional view a writing instrument in a first embodiment of the present invention;

FIG. 2 is a side cross-sectional view of a writing instrument in a second embodiment of the present invention;

FIG. 3 is a side cross-sectional view of a writing instrument in accordance with a third embodiment of the present invention; and

FIG. 4 is a side cross-sectional view of a fourth embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

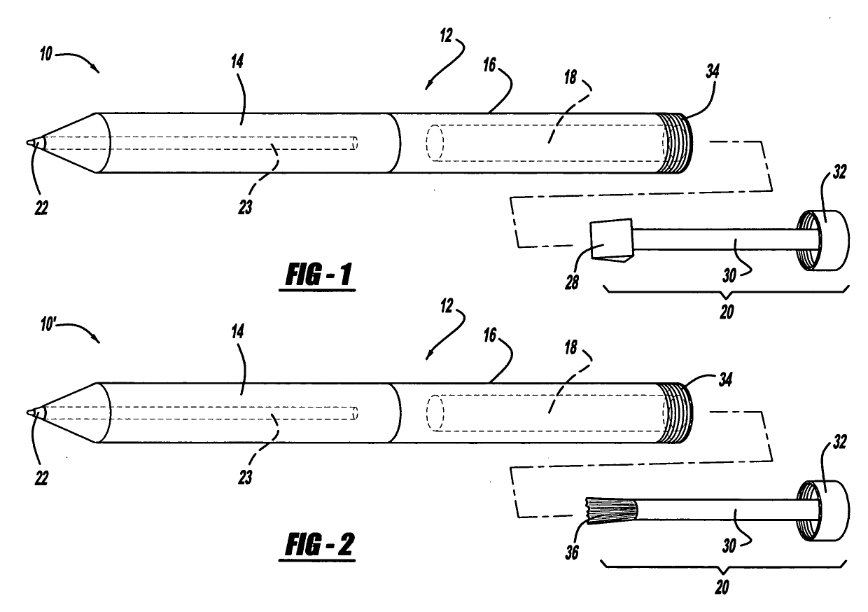

Referring now to FIG. 1 a writing instrument 10 in accordance with a first embodiment of the present invention is described. The writing instrument 10 in this particular embodiment has a housing 12 with a writing portion 14 and a correction portion 16. The correction portion 16 can take many forms. Additionally the correction portion 16 as shown in all figures can be a removable unit that can be replaced with a new correction portion. The correction portion 16 of this depicted in FIG. 1 of the invention has a fluid chamber 18 with an applicator 20. This particular embodiment uses an applicator 20 that is a sponge 28 connected to a stem 30 that is connected to a cap 32. The cap 32 has threads on its interior surface that are configured to align with threads 34 formed on the exterior surface of the housing 12. The stem 30 is elongated to allow the sponge 28 to extend within the fluid chamber 18. The sponge 28 soaks up correction fluid that is contained within the fluid chamber 18, and then applies the correction fluid by wiping the sponge 28 with correction fluid over the area to be corrected.

The writing portion 14 of the writing instrument 10 has a writing tip 22. The writing tip 22 can be a stationary or fixed tip or it can be attached to a retraction mechanism for retracting the writing tip into the housing 12. The writing tip 22 receives writing fluid such as ink from an ink holder 23. The ink holder can be an ink well, ink cartridge or other suitable ink delivery system.

FIGS. 2-4 depict alternate embodiments of the invention, where applicable like reference numerals will be used to show like structures to those described above and shown in FIG. 1. Referring now to FIG. 2 a second embodiment of a writing instrument 10′ is depicted. In this particular embodiment of the invention the applicator 20 is a brush 36 connected to the stem 30. The brush 36 is a different type of applicator for applying correction fluid.

FIG. 3 shows a third embodiment of the invention where a writing instrument 10″ has a pen applicator 38 in the correction portion 16 that is operably connected to the housing 12. The pen applicator 38 can be a separate component that is connected to the housing 12 or it can be integrally formed or molded with the housing 12. The pen applicator has a tip 40 that dispenses correction fluid from the fluid chamber 18.

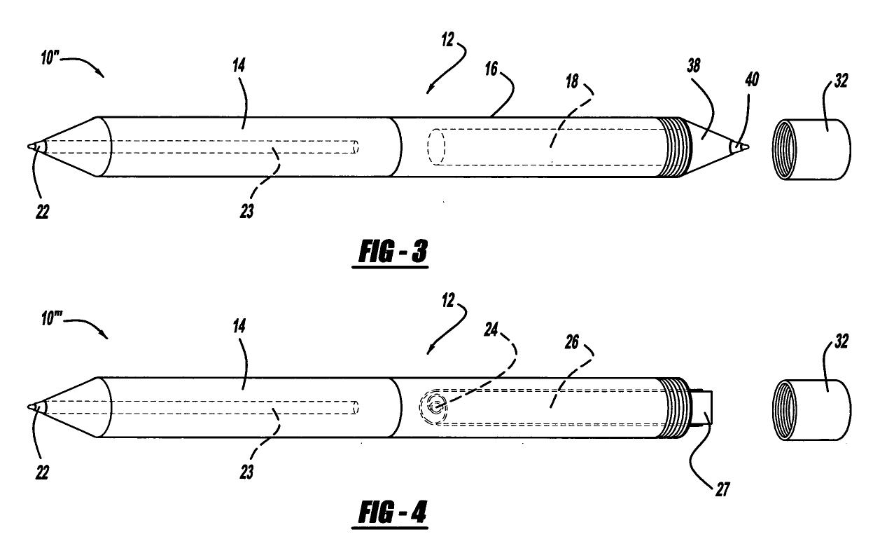

FIG. 4 depicts a fourth embodiment of the invention where a writing instrument 10′″ has a dry line wheel 24 positioned within the housing 12. The dry line wheel 24 has correction tape 26 wound thereon. The correction tape 26 extends to a depressor 27 that is used to apply the correction tape 26 over a mistake. This particular embodiment of the invention eliminates the need to have a fluid chamber 18 with correction fluid. The depressor 27 is connected directly to the correction portion 16 of the housing 12. The depressor 27 can also be integrally formed with the housing 12 or may be a separate unit that is inserted into the housing. Additionally, the dry line wheel 24 and depressor 27 can be a single molded piece that is inserted into the housing 12.

The writing instruments 10, 10′, 10′″ shown in FIGS. 1-3 can have the fluid chamber 18 molded into the housing 12. Alternatively a plug can be inserted into the housing 12 creating a chamber in the housing 12 for storing correction fluid. Using a plug in the housing 12 can cut down the manufacturing time and costs for creating the writing instruments discussed above. The plug can be made of silicone, adhesives, polymers or other suitable material that will prevent the correction fluid from moving into the writing portion 14.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A writing instrument comprising:
a housing;
a writing portion at least partially contained in said housing and having a writing tip extendable from said housing; and
a correction portion at least partially disposed in said housing, wherein said correction portion has an applicator connectable to said housing.

2. The writing instrument of claim 1 wherein said correction portion further comprises a fluid chamber at least partially disposed in said housing and said applicator removably positioned in said fluid chamber.

3. The writing instrument of claim 2 wherein said applicator is a brush or sponge connected to a cap that is connectable to said housing.

4. The writing instrument of claim 1 wherein said correction portion comprises a fluid chamber at least partially disposed in said housing and said applicator is connected to said housing and has a tip that dispenses fluid from said fluid chamber.

5. The writing instrument of claim 1 wherein said writing portion has a mechanism for retracting and extending said writing tip from said housing.

6. The writing instrument of claim 1 wherein the correction portion can be removed and replaced with a new correction portion.

7. A writing instrument comprising:
a housing having a first end and a second end;
a writing portion positioned at said first end of said housing and said writing portion is at least partially contained in said housing, wherein said writing portion has a writing tip extendable from said housing; and
a correction portion connected to said second end of said housing, wherein said correction portion is at least partially disposed in said housing and said correction portion has an applicator connectable to said correction portion of said second end of said housing.

8. The writing instrument of claim 7 wherein the correction portion can be removed and replaced with a new correction portion.

9. The writing instrument of claim 7 wherein said correction portion further comprises a fluid chamber at least partially disposed in said housing and said applicator removably positioned in said fluid chamber.

10. The writing instrument of claim 9 wherein said applicator is a brush or sponge connected to a cap that is connectable to said housing.

11. The writing instrument of claim 7 wherein said correction portion comprises a fluid chamber at least partially disposed in said housing and said applicator is connected to said housing and has a tip that dispenses fluid from said fluid chamber.

12. The writing instrument of claim 7 wherein said writing portion has a mechanism for retracting and extending said writing tip from said housing.

13. A writing instrument comprising:
a housing;
a writing portion at least partially contained in said housing and having a writing tip extendable from said housing;
a correction portion having a cartridge at least partially disposed in said housing, a rotatable wheel having one or more layers of correction tape removably rolled onto said rotatable wheel, an applicator connectable to said cartridge, wherein said correction tape is operably connected to said applicator.

14. The writing instrument of claim 13 wherein said correction tape is a dry line correction tape or an adhesive tape having a sticky surface and a writing surface.

15. The writing instrument of claim 13 wherein the correction portion can be removed and replaced with a new correction portion.
